(19) United States
(12) Patent Application Publication
(10) Pub. No.: US 2007/0097212 A1
(43) Pub. Date: May 3, 2007

(54) 360 Degree surveillance system and method

(76) Inventor: John Otis Farneman, Powell, OH (US)

Correspondence Address: LAW OFFICE OF TIMOTHY M. BARLOW, P.O. BOX 523272, SPRINGFIELD, VA, 22152, US

(21) Appl. No.: 11/525,477

(22) Filed: Sep. 22, 2006

Related U.S. Application Data
(60) Provisional application No. 60/719,348, filed on Sep. 22, 2005.

(51) Int. Cl. H04N 7/18

(52) U.S. Cl. 348/143

(57) ABSTRACT

A 360 degree surveillance system includes a 360-degree digital camera, a power source, a camera control system, a portable digital storage medium, a wireless communications system, and an archive digital storage medium. The digital camera has a fixed lens unit with a simultaneous 360-degree panoramic view, or a movable lens unit that is remotely controllable for pan, tilt and zoom. A remote control system is wirelessly linked to the wireless communications system. The wireless communications system sends the images to a computer network for viewing with a standard web browser, PDA, or dedicated monitoring system. The 360 degree surveillance system monitors an area with a camera; directs the camera with a control system; collects a plurality of images; stores the images on the portable storage medium; uploads the images to an archive storage medium; and creates a plurality of archived images on the archive storage medium.

### PRIORITY DATA

This application claims benefit of U.S. Provisional Patent Application Ser. No. 60/719,348, filed Sep. 22, 2005, entitled 360 Degree Surveillance Light Bar, and U.S. patent application Ser. No. 11/232,498, entitled Mobile Video Surveillance System, filed on Sep. 22, 2005 and are hereby incorporated by reference.

### BACKGROUND OF THE INVENTION

1. Field of the Invention

The present invention relates generally to the field of electronic surveillance equipment, and more particularly to a 360 degree surveillance system with automated data protection features.

2. Description of the Related Art

Video cameras have been used for many years to monitor private property and business interests. The main focus of such systems is to prevent theft, damage or other losses in building and other permanent structures. Mobile systems were unheard of due to their bulky size, power requirements and limited duration of the film or videotape within the machine. Modern advances have lead to the development of a camera that is significantly smaller than its predecessors and that has much lower power requirements. However, such cameras are still limited in their storage capacity to some extent. Further, replacing the storage media is a time-consuming task that a police officer, bus driver or other person can ill afford at times.

Thus what is desired is a 360-degree surveillance system that fits unobtrusively into existing stationary and automotive systems and that incorporates automated features that eliminate the need to directly handle the storage media to change it.

Additionally, video security systems are well known. Such devices include closed-circuit television systems (CCTV), simple motion-picture video cameras with recording media within the camera or remotely located, and cameras that record a series of still images in response to a stimulus. These systems all have several drawbacks. The foremost of these is that the camera systems need to be permanently mounted or fixed into a vehicle, building or other structure. These systems require both power and transmission cables to feed power to the camera and to transmit images and information to a user. Simply setting up such a camera with its power supply and communications cables can take many hours to several days, depending upon the location of the camera and its surroundings. Currently, there is no ability to quickly deploy a camera that is entirely self-contained.

Therefore, there has been and continues to be a need for a surveillance camera system that is completely self-contained, so that it requires no external cabling. Such a camera system requires no permanent mounting location or dedicated supports, enabling it to operate properly from nearly any location, environment and position.

### SUMMARY OF THE DISCLOSURE

The device is a mobile and portable video surveillance system that is integrated into automobiles, such as police vehicles, school buses, city transit buses, aircraft, trains and other mass transit systems. The device is permanently affixed within or around such vehicles, but can also be a self-contained portable unit that can be set up in any location very quickly. A portable unit can be set up and operational within a few minutes or less.

The 360 degree surveillance system includes a 360-degree field of view digital camera, a power source attached to the digital camera, a camera control system attached to the digital camera, a portable digital storage medium attached to the digital camera and the power source, a wireless communications system linked to the digital storage medium and the digital camera, and an archive digital storage medium wirelessly linked to the wireless communications system. The digital camera can have a fixed lens unit with a simultaneous 360-degree panoramic view, or a movable lens unit that is remotely controllable for pan, tilt and zoom. A camera control system is hardwired or wirelessly linked to the wireless communications system. The wireless communications system sends the images to a computer network for viewing with a standard web browser, PDA, or dedicated monitoring system. An acoustic sensor may be attached adjacent to the digital camera, and a motion sensing system may be incorporated into the portable digital storage medium.

The 360 degree surveillance system monitors an area with a digital camera, directs the digital camera with a camera control system, collects a plurality of images, stores the plurality of images on the portable digital storage medium, automatically uploads the plurality of images to an archive digital storage medium, and then creates a plurality of archived images on the archive digital storage medium.

A vehicle-oriented system permits the camera operator, driver, conductor or pilot to observe live images from the interior or exterior of the vehicle. For example, a pilot can view into the passenger section of an airliner to observe and report any trouble. The wireless communications system permits observers on the ground to see these images as well. In another example, a SWAT team could place a portable camera unit in front of a building in a minute or less and monitor the building from a concealed position immediately.

Such a device is operable from a considerable distance, depending on terrain and the type of wireless communication system used. Such a device saves labor costs and is not an obvious, intrusive observational presence. A number of mobile video surveillance systems can be placed around a building so that one man can do the surveillance and monitoring of six men or more. The information from the mobile video surveillance system is all viewable from a standard web browser or dedicated monitor.

As another example, the mobile video surveillance system can be set up on building tops in a matter of minutes to unobtrusively observe events in a city environment.

It is an object of the invention to provide improved elements and arrangements thereof for the purposes described which is inexpensive, dependable and fully effective in accomplishing its intended purposes.

It is an object of the present invention to accomplish the foregoing objectives in a simple and cost effective manner.

These and other objects of the present invention will become readily apparent upon further review of the following specification and drawings.

### BRIEF DESCRIPTION OF THE DRAWINGS

FIG. 1 is an environmental view of the 360 degree surveillance system in a police car, in accordance with the present invention;

FIG. 2 is an environmental view of the 360 degree surveillance system in a school bus, in accordance with the present invention;

FIG. 3 is a perspective view of the 360 degree surveillance system in a self-contained package, in accordance with the present invention;

FIG. 4 is a flowchart of the steps in the 360 surveillance system, in accordance with the present invention; and

FIGS. 5A-5D are environmental views of the 360 degree surveillance system, in accordance with the present invention.

### DETAILED DESCRIPTION OF THE PREFERRED EMBODIMENT

The following detailed description is of the best presently contemplated modes of carrying out the invention. This description is not to be taken in a limiting sense, but is made merely for the purpose of illustrating general principles of embodiments of the invention.

The present invention provides a 360 degree video surveillance system and method that provide security and flexibility to the users.

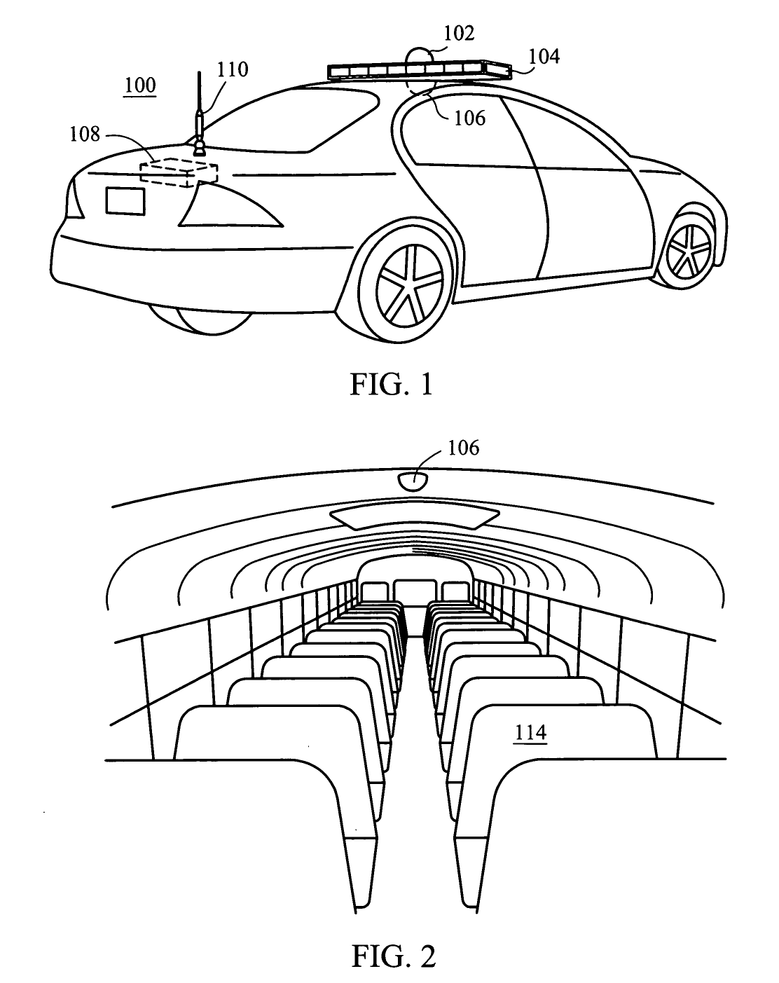

FIG. 1 shows an environmental view of the 360 degree surveillance system 100 in a police car. The surveillance system 100 includes a digital camera 102 with a 360 degree field of view. In this embodiment, the camera 102 is mounted atop the police car's light bar 104 for maximum exterior visibility with a single camera 102. In another embodiment, multiple cameras could be in a lower position so that the cameras provide a total 360 degree view. An interior camera 106 also provides a 360 degree view, but is inside the police car. This arrangement provides maximum visibility both inside and outside the police car. Each camera 102, 106 is attached to a power source, such as battery power from the police car, and can also include a backup battery for each camera in case of power failure. Each camera 102, 106 is linked to a camera control system so that a camera operator can selectively direct the motion or each camera 102, 106. Current police cars are equipped with computers that are accessible by the police officer. The camera control system is a small software addition to the computer.

A portable digital storage medium 108 is attached to the digital camera 102, 106, the power source, and the camera control system. As shown in FIG. 1, the portable storage medium 108 could be located in the vehicle's trunk. Shielded cables can be run between all the separated components. The portable storage medium 108 may be a dedicated digital video recorder, or simply an external hard drive with sufficient capacity to record many hours of digital images. A wireless communications system 110 is linked to the portable storage medium 108 and the digital camera 102, 106. Many police cars are already equipped with wireless communications systems 110 to provide real time information to the police officer through the onboard computer.

An archive digital storage medium 112 is located remotely, such as police headquarters, and is wirelessly linked to the wireless communications system 112 onboard the police car.

Many options are available for the 360 degree surveillance system. In one embodiment, the digital camera 102, 106 has a fixed lens unit. This means that the lens cannot be slewed in any direction. In one embodiment, the camera 102, 106 is looking in one direction all the time and cannot be moved via the camera control system. In another embodiment, the digital camera 102, 106 has a simultaneous 360-degree panoramic view. Thus, the camera 102, 106 does not need to slewed to view a different scene. Instead, the camera control system is used to select the part of the panoramic view that is at the center of the viewed image.

In one embodiment, the digital camera 102, 106 has a movable lens unit. A movable lens unit means that the lens unit within the camera housing can be slewed to a desired position by the user. In another embodiment, the movable lens unit is remotely controllable.

In one embodiment, a camera control system is wirelessly linked to the wireless communications system. Alternatively, the camera control system can be hardwired into the wireless communications system.

To provide more information than simple digital images, the 360 degree surveillance system 100 may also include at least one acoustic sensor attached adjacent to the digital camera. The acoustic sensor may be a directional microphone or a omni-directional microphone to provide audio information to supplement the digital images. The omni-directional microphone is capable of picking up audio information from all directions equally well, while the directional microphone would have superior performance in only one direction. Thus, the directional microphone would need to be slewed for optimal performance. In one embodiment the directional microphone is slewed to the strongest audio source by a microphone control system, or to correspond to the desired images selected via the camera control system. Thus, the directional microphone could be slewed to match the orientation of the camera 102, 106.

To supplement the camera control system, the 360 degree surveillance system 100 may further include a motion sensing system incorporated into the portable digital storage medium 108. Such a system would be quite useful with the panoramic camera 102, 106 so that the portion of the image that includes motion is centered for display. Motion sensing software can compare consecutive images to determine where any differences are, if any.

The user has numerous hardware options for the 360 Degree Surveillance System 100. For example, the camera 102, 106 may be one of several currently on the market, such as the AXIS 232d Network Dome Camera. Such a camera has day and night capability, variable frame rate and resolution, 360-degree pan and 90-degree tilt, both optical and digital zoom capability, and supports encrypted communications. Of course, other cameras with similar or greater capabilities may be used depending upon the application, such as the Sony RPU-C2512 or RPU-C3522. The Sony product operates on only 6-8 volts, but at a lower resolution. Thus, the user has several options from which to create the optimal device for his application. If properly equipped, the device can also transmit audio information to the user.

In one embodiment, the wireless communications system includes an industrial high-speed secure Ethernet radio. For example, with a LOCUS OS2400-HSE Industrial High Speed Ethernet Radio, the range is up to about five miles in rough terrain or urban environments, and up to 25 miles for line-of sight operation. Communications to and from the radio may be encrypted so that unauthorized persons cannot access the transmitted images or affect camera operation. The radio is secure and fast.

Virtually any device that can receive and display the images can be a part of the wireless communications system. The wireless communications system may provide images and information to a server for distribution to the Internet. From the Internet, authorized users can access the images from virtually anywhere in the world.

The wireless communications system processes the radio signals for distribution to a broadcast antenna or an Internet server. Alternatively, radio signals can be sent and received at a viewing monitor directly, without the middle parts of a wireless communications system. The viewing monitor may be a PDA, personal computer or other device capable of receiving and displaying the image data from the camera 102, 106 and the wireless communication system 110.

The user who is controlling the camera 102, 106 may be located nearby or virtually anywhere in the world when the signals are sent through the Internet.

FIG. 2 is an environmental view of the 360 degree surveillance system 100 in a school bus 114. The camera 106 is shown mounted on the ceiling inside the bus 114. A single camera 106 can be mounted at the front or rear of the bus 114, or multiple cameras can be used simultaneously for maximum coverage. As with the police car example, the camera 106 is attached to a power source from the bus 114, and is linked to a portable digital storage medium 108 somewhere on the bus 114. It may not be necessary to have a camera control system aboard the bus 114, because the driver typically operates alone and does not have time to drive and operate a camera 106 simultaneously. However, as with the police car, a wireless communications system is linked to the portable digital storage medium 108 and the digital camera 106 so that the camera 106 can be accessed and directed remotely. This option can be very helpful where there is trouble aboard the bus 114. The remote observers can become eyewitnesses to the actual conditions aboard the bus 114. This applies to the police car example as well. Alternatively, the bus 114 could be a train, aircraft or other form of public transportation.

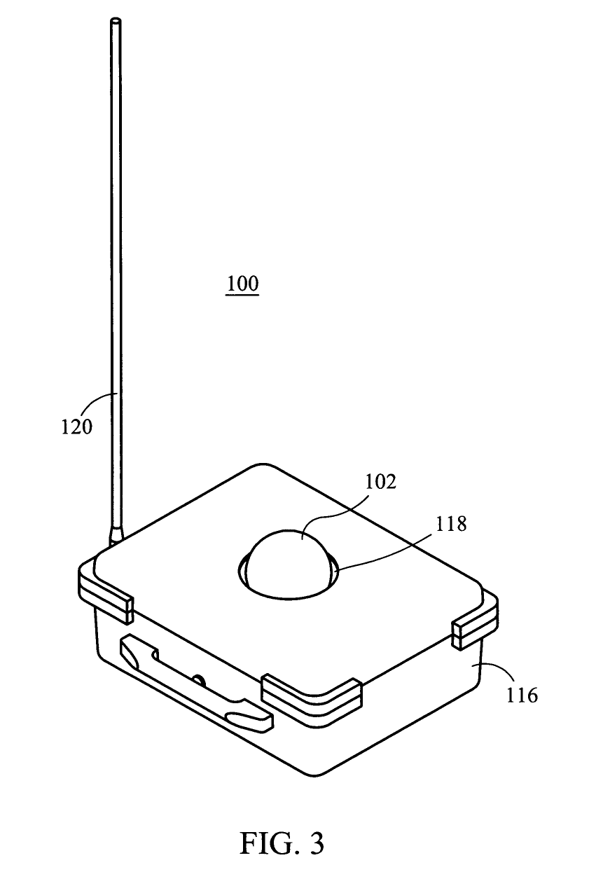

FIG. 3 is a perspective view of the 360 degree surveillance system 100 in a self-contained package. The camera 102 is housed within a waterproof and shock-resistant housing 116 having a lid and a base. For example, a Pelican® brand case, could be used to house the entire device. The camera 102 protrudes through an aperture 118 in the housing 116 and is protected by a transparent dome. A gasket or seal may be provided at the interface between the dome and the lid to guard against moisture and dirt. An antenna 120 is shown attached to the side of the housing base. The antenna cable is routed through a watertight grommet on the side of the housing 116 base where it attaches to an internal wireless communications system. The power supply and the portable digital storage medium 108 are found within the housing 116. In another embodiment, the antenna 120 is completely inside the housing 116, providing a less conspicuous package.

Operation of the 360 Degree Surveillance System

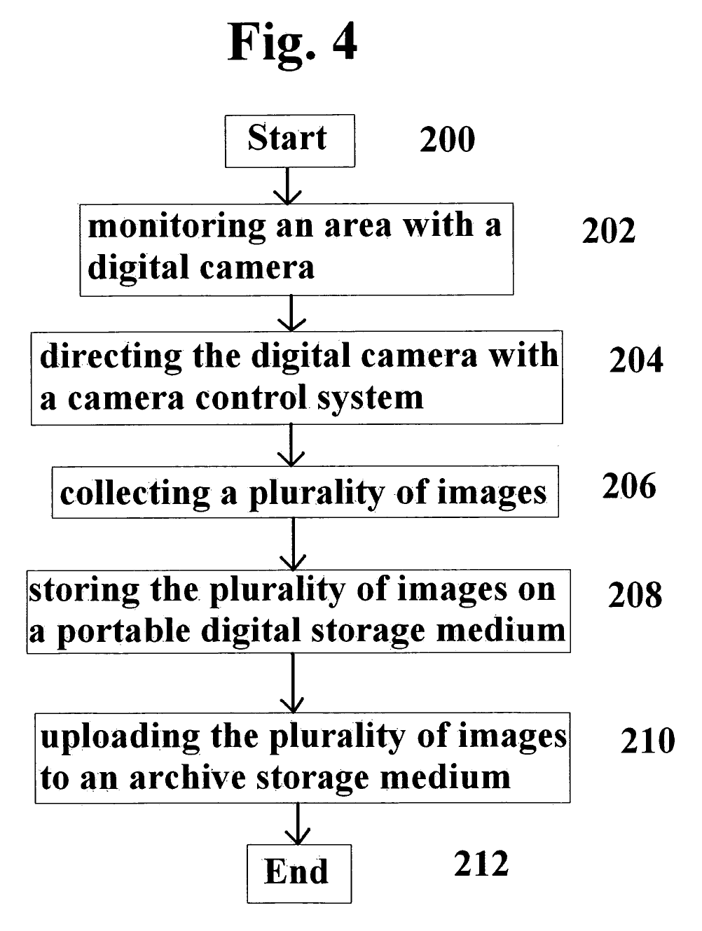

The 360 degree surveillance system is quite simple to use and powerful in operation. FIG. 4 shows a flowchart for a method of operating a 360 degree surveillance system 100. The process starts, step 200 as the system monitors an area with a digital camera, step 202. Next, step 204, an operator directs the digital camera 102, 106 with a camera control system. The operator's options may be limited, depending on the type of camera 102, 106 that is used. First, if there is more than one camera 102, 106 in the system, the operator must select the camera 102, 106 to be viewed. Multiple cameras 102, 106 can be viewed simultaneously. If the cameras 102, 106 are on a secure network, selection of a particular camera 102, 106 may require that the operator enter the IP address, username or a password for the desired camera 102, 106. A common graphical user interface provides places to enter the appropriate information required to gain access. If the wireless system is integrated into a network that is accessible through the Internet, then users can log in to view images from a desired camera 102, 106 anywhere there is Internet access. The user can also select the type of viewing method to use, such as server-push stream, which works well for most applications. The user can also select the image viewing size. 320×240 is best for a slower Internet connection, while 640×480 is a larger size that should be reserved for faster Internet connections.

The operator can select whether the camera control system should automatically slew the camera 102, 106 to track motion or sound, or the camera control system can be used to manually slew the camera 102, 106 or digital image. As described above for FIG. 1, the operator will slew the camera 102, 106 if it is a movable lens unit, and will slew the image for fixed lens, panoramic cameras. The operator may also select the image viewing size or definition of the digital images. If manually slewing a camera 102, 106, the operator will want to activate a pan-tilt-zoom (PTZ) control. The PTZ control can be an array of buttons for incremental left, right, up and down, and zoom in or out. Alternatively, the PTZ control can be a joystick with a zoom wheel. The joystick option provides more seamless inputs to the camera.

Next, step 206, the system collects a plurality of images. The images may be video images, still images, or sequential still images. The digital images may be collected at a variety of rates, depending on the capabilities of the camera and the camera control system.

Next, step 208, the system stores the plurality of images on the portable digital storage medium 108. The system stores the digital images as quickly as they are produced. If the system has a microphone, the audio information is stored with the corresponding digital images. The system assigns a unique identification code to each of the plurality of images. The identification code can be customized to identify images by the particular camera 102, 106 that made them, subject, location, time of day, a sequential numbering system, and many other factors and combinations.

Next, step 210, the system automatically uploads the plurality of images to an archive digital storage medium 112, ending the process, step 212. This archive medium 112 is not located with the portable medium 108. The archive is a more permanent repository of digital images for one or more cameras 102, 106. The archive medium 112 can be at a police headquarters, school district administration, bus garage, airport terminal, or can be in a mobile archive unit.

First, the camera operating system detects a wireless link to the archive digital storage medium 112. The camera operating system may automatically log in to the archive system and will then detect a secure wireless link. Once a secure wireless link is established, the archive storage system 112 will identify which of the plurality of images on the portable medium 108 have not been uploaded to the archive medium 112. Those identified images are then uploaded to the archive medium 112. When the upload is complete and confirmed, the uploaded images are erased from the portable digital storage medium 108. Thus, a plurality of archived images is created on the archive digital storage medium 112, without any manual handling or transfer of the portable storage media 108. The upload or transfer of the digital images to the archive storage medium 112 can be completely automated. It can be scheduled to occur anytime the portable storage medium 108 is within a predetermined range of the archive storage medium, or at a particular time of day, or can be manually prompted by an operator.

Images stored on the archive storage medium 112 can be accessed immediately or at a future time using any of the tags or unique identifiers attached earlier. To search the archives, the user opens the archive access system, selects a date and clicks the “Search” button. The user can select a particular camera and time to execute a more specific search. After the search is completed, another box on the web page lists all of the archived video that meets the search parameters. The user can select one or more videos to play back. A user can also save comments in the video file. If he sees something important in a video, he can label the file and leave a comment.

The mobile archive unit is a traveling archive medium 112 that pays scheduled visits to banks, retail establishments and other permanently fixed surveillance sites. As with the other variations, the users and operators do not need to directly handle any storage media 108, 112. The mobile archive unit positions itself in close proximity to the retail establishment or bank and initiates the uploading process. Once uploaded to the mobile archive unit, the stored images are taken to a designated facility for final storage and possible review at a later time.

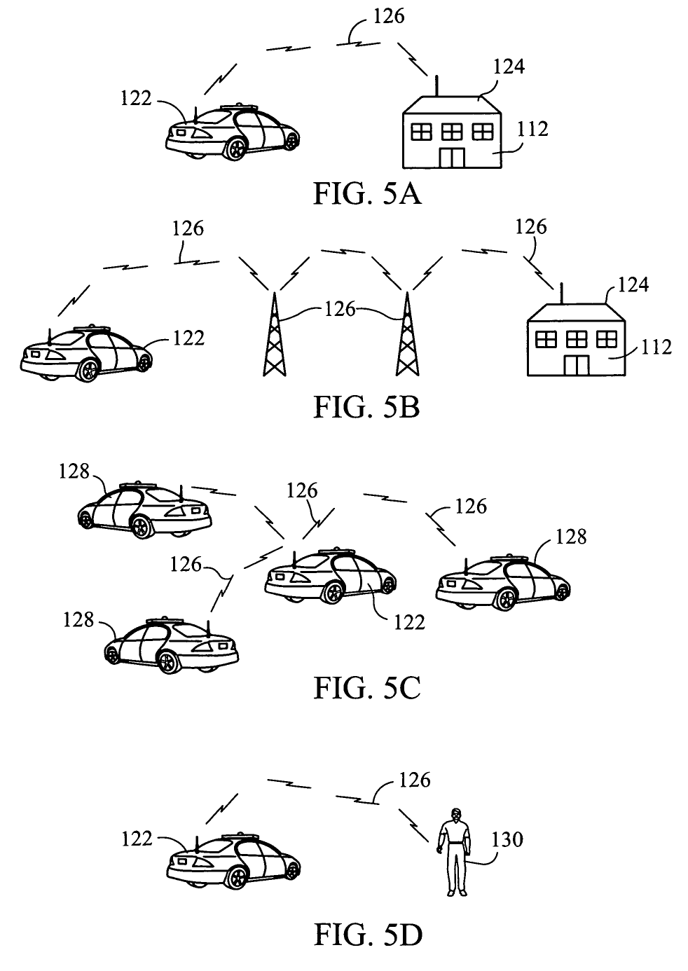

FIGS. 5A-5D are environmental views of the 360 degree surveillance system in operation.

FIG. 5A shows a police car 122 in proximity with a police headquarters 124. The police car 122 could also be a the self-contained camera shown in FIG. 3, an aircraft, or a school bus, city bus, subway, train or other form of public transportation or mass transit. Image files are automatically uploaded via a secure wireless link from the portable storage medium 108 to the archive storage medium 112 inside police headquarters 124.

FIG. 5B shows how live images from a camera 102, 106 can be viewed remotely. An operator at headquarters 124 enters the IP address, username or password for the desired camera 102, 106 and thereby achieves access to the camera 102, 106. The operator can then direct that camera 102, 106 via the camera control system. This feature is particularly helpful where trouble is reported on a bus or other public transportation, or just to monitor conditions aboard the transportation. In the case of a police car 122, the remote control of the camera 102, 106 enables police commanders, SWAT, FBI and others to see what the officers on the scene are seeing. When the self-contained camera (see FIG. 3) is used, it can be placed surreptitiously so that local events can be monitored remotely by authorized individuals.

FIG. 5C shows how numerous parties can view live images from a single camera 102, 106. Here, police car 122 is on the scene of an incident. Remote police cars 128 enter the IP address of the desired camera 102, 106 and a valid username or password. In cases like this, it is not practicable for each remote viewer to control the camera 102, 106 remotely. In such cases control is limited to the operator who is with the camera 102, 106, or to a supervisor some other party with an overriding username or password.

FIG. 5D shows that many wireless devices can be used to monitor live images from the camera 102, 106. Here, a wireless handheld device 130, such as a personal digital assistant (PDA), cell phone, or other wireless device having Internet access can be used to receive live images from the desired camera 102, 106.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A 360 degree surveillance system comprises:
a 360-degree field of view digital camera;
a power source attached to the digital camera;
a camera control system attached to the digital camera;
a portable digital storage medium attached to the digital camera and the power source;
a wireless communications system linked to the digital storage medium and the digital camera; and
an archive digital storage medium wirelessly linked to the wireless communications system.

2. The 360 degree surveillance system of claim 1, where the digital camera has a fixed lens unit.

3. The 360 degree surveillance system of claim 2, where the digital camera has a simultaneous 360-degree panoramic view.

4. The 360 degree surveillance system of claim 1, where the digital camera has a movable lens unit.

5. The 360 degree surveillance system of claim 4, where the movable lens unit is remotely controllable.

6. The 360 degree surveillance system of claim 5, further comprising a remote control system wirelessly linked to the wireless communications system.

7. The 360 degree surveillance system of claim 1, further comprising at least one acoustic sensor attached adjacent to the digital camera.

8. The 360 degree surveillance system of claim 5, further comprising a motion sensing system incorporated into the portable digital storage medium.

9. A method of operating a 360 degree surveillance system, comprising the steps of:
(a) monitoring an area with a digital camera;
(b) directing the digital camera with a camera control system;
(c) collecting a plurality of images;
(d) storing the plurality of images on the portable digital storage medium;
(e) automatically uploading the plurality of images to an archive digital storage medium; and
(e) creating a plurality of archived images on the archive digital storage medium.

10. The method of operating a 360 degree surveillance system of claim 9, where step (b) further comprises the step of:
(b1) automatically stewing the camera to track motion.

11. The method of operating a 360 degree surveillance system of claim 9, where step (b) further comprises the step of:
(b1) automatically slewing the camera to track sound.

12. The method of operating a 360 degree surveillance system of claim 9, where step (b) further comprises the step of:
(b1) manually slewing the camera.

13. The method of operating a 360 degree surveillance system of claim 9, where step (b) further comprises the step of:
(b1) selecting a camera with the camera control system.

14. The method of operating a 360 degree surveillance system of claim 9, where step (d) further comprises the step of:
(d1) assigning a unique identification code to each of the plurality of images.

15. The method of operating a 360 degree surveillance system of claim 9, where step (e) further comprises the step of:
(e1) detecting a link to the archive digital storage medium;
(e2) identifying which of the plurality of images have not been uploaded; and
(e3) uploading the identified images;

16. The method of operating a 360 degree surveillance system of claim 9, further comprising the step of:
(g) accessing the archived images.

17. The method of operating a 360 degree surveillance system of claim 13, where step (b1) further comprises the step of:
(i) activating a pan-tilt-zoom (PTZ) control.

18. The method of operating a 360 degree surveillance system of claim 17, where the PTZ control is a graphical user interface having a plurality of direction buttons.

19. The method of operating a 360 degree surveillance system of claim 17, where the PTZ control is a joystick.

20. The method of operating a 360 degree surveillance system of claim 15, where step (e) further comprises the step of:
(e4) erasing the uploaded images from the portable digital storage medium.
